(19) United States
(12) Patent Application Publication
(10) Pub. No.: US 2023/0117346 A1
(43) Pub. Date: Apr. 20, 2023

(54) System for Monitoring the Surround of a Motor Vehicle

(71) Applicant: ZKW Group GmbH, Wieselburg (AT)

(72) Inventors: Christoph BIERWIPFL, St. Martin-Karlsbach (AT); Thomas REITER, Ferschitz (AT); Stefan WEISSENSTEINER, Waldenstein (AT)

(21) Appl. No.: 17/908,608

(22) PCT Filed: Mar. 2, 2021
(86) PCT No.: PCT/EP2021/055118

§ 371 Date: Sep. 1, 2022

(30) Foreign Application Priority Data
Mar. 2, 2020 (EP) 20160398.2

(51) Int. Cl. G06V 10/141; G06V 20/58; G06V 10/776; G06V 10/22; B60Q 1/14; B60Q 1/00

(52) U.S. Cl. CPC G06V 10/141; G06V 20/58; G06V 10/776; G06V 10/22; B60Q 1/143; B60Q 1/0023; B60W 60/00

(57) ABSTRACT

The invention relates to system (1) for monitoring the environment of a motor vehicle (100), the system (1) comprising an image capture device (2) for sensing objects in the sensing region (E1), an illuminating device (3) for illuminating the sensing region (E1), and an environment sensing device (7) for sensing a part of the sensing region (E1) of the image capture device (2), wherein the system (1) is designed to classify, in terms of object type, an object situated in a sensing region of the at least one image capture device (2), when said object has been detected, and in each case to determine a confidence value, the so-called KO confidence value, “KO”, said KO indicating the probability that the object type of a detected object can be established, in particular correctly, by the image capture device (2), and wherein the system (1) is designed, when there is an object (OBJ) in the sensing region (E1), depending on the KO for the detected object (OBJ), or when the environment sensing device (7) detects the object, and this object is not detected by the image capture device (2), or when the environment sensing device (7) detects the object, and this object is detected but cannot be classified by the image capture device (2), or the KO falls below a defined threshold value, or if the system (1) or the environment sensing device (7) is designed to classify, in terms of type, an object sensed by the environment sensing device (7) and situated and detected in the sensing region (E1) of the illuminating device (2) and to determine a further confidence value, the so-called NKO confidence value, “NKO”, said NKO indicating the probability that the object type of the detected object has been established, in particular correctly, depending on the NKO for the object (OBJ), or depending on the KO and the NKO for the object (OBJ), or if KO<NKO, or to actuate the illuminating device (3) such that the illumination intensity is increased or decreased or is not changed in the region of the object (OBJ).

The invention relates to a system for monitoring the environment of a motor vehicle, in particular of an autonomous or semi-autonomous motor vehicle, the system comprising:
at least one image capture device, in particular an optical image capture device, wherein the image capture device is designed to sense a sensing region of the environment, in particular to sense objects within the sensing region,
at least one illuminating device, wherein the sensing region of the at least one image capture device can be illuminated partially, preferably fully, by the illuminating device, and
at least one environment sensing device, wherein the environment sensing device is designed to sense at least a part of the sensing region of the image capture device, preferably the entire sensing region, wherein the at least one environment sensing device is designed in particular to detect objects,
wherein the image capture device is designed
   to classify, in terms of object type, an object situated in a sensing region of the at least one image capture device, when said object has been detected, and
   in each case to determine a confidence value, the so-called KO confidence value, “KO”, said KO indicating the probability that the object type of a detected object can be established, in particular correctly, by the image capture device.

The invention also relates to a motor vehicle headlight for a motor vehicle, in particular an autonomous or semi-autonomous motor vehicle, the motor vehicle headlight comprising such a system.

In a motor vehicle such as a car, image capture devices are now often provided, by means of which the environment of the motor vehicle, for example the region in front of the motor vehicle as seen in the direction of travel, can be monitored. The image capture device can comprise e.g. an object recognition unit and/or a pattern recognition unit, or one or more such units are connected to the image capture device. In this way, e.g. persons and/or preceding vehicles and/or oncoming vehicles and/or road markings and/or traffic signs etc. can be detected.

In the present text, a distinction is made between the terms “detect” and “classify” (or recognise). The term “detect” means that a device recognises the presence of an object within its sensing region (“detection”) but does not necessarily recognise what object, i.e., what type of object (person, car, truck, bicycle, traffic sign etc.) it is (“classification”). If a device can also identify the type of object, this is called “classifying”. The probability that a device can identify an object correctly in a certain situation is described using the so-called confidence value (for said device). The confidence value depends on the one hand on the specific situation (e.g. brightness, relative speed between object and device, angle between object and device, distance between the object and the device etc.) and on the other hand on how well the device hardware and/or software is configured for classification. While the first point cannot in fact be influenced, the second aspect depends on the basic design of the device and on how well its software/algorithms are configured and trained.

The term “image capture device” means devices which are basically designed to be able not only to detect an object but also to classify it.

An “environment sensing device” has the minimum requirement that it is designed to detect objects without having to be able to classify them, but environment sensing devices which are also suitable for classification can also be used.

It can thus be provided for an environment sensing device to be designed to detect objects but not to classify them.

It can however also be provided for an environment sensing device to be designed to detect objects and classify them.

To allow reliable detection and/or object recognition, as is used in particular for semi-autonomous or autonomous vehicles but also for assistance systems in modern vehicles, aforementioned systems which on the one hand have an image capture device and additionally at least one additional environment sensing device are very advantageous, since the reliability can be increased considerably by sensing a sensing region and objects situated therein by two or more devices (e.g. key term “sensor fusion”).

In such systems, in particular an image capture device is used, which is preferably an optical device, i.e., a device operating in the visible light range, sometimes also in the IR spectrum range, for example using one or more suitable cameras or camera systems (optical and/or IR range). Such image capture devices are also suitable for classifying objects.

With an above-described arrangement, the high current demands, which will probably increase further in the future, of driver assistance systems and autonomous vehicles can be met well under many environmental conditions. Any sensor system, i.e., any sensing device, has a limited operating range; combination of different sensor systems or sensor technologies makes reliable object detection and classification possible under many conditions.

In particular cameras are very important for controlling self-driving vehicles and also for driving assistance systems, since they are currently the only type of sensor device (sensing device) which can reliably carry out object recognition and classification as a rule. The reliability of the recognition is defined by the confidence value, as already described above. Said confidence value describes how confident the device is that the object is a certain object (e.g. a car) which the system can classify.

For example, during night-time driving, poor weather conditions (rain, fog, snow, spray) or glare (reflected or direct glare), situations, in particular safety-critical situations can occur in which the confidence value falls below a confidence level or a threshold value below which a reliable object classification no longer exists. As a result, the usability of an aforementioned system is greatly limited, since there can be a large number of situations in which an object classification does not reliably exist.

It is an object of the invention to specify a solution to the problem of how the detection and classification of objects can be improved.

This object is achieved in that the system is designed, according to the invention, when there is an object in the sensing region,
when the environment sensing device detects the object, and this object is not detected by the image capture device, or
when the environment sensing device detects the object, and this object is detected by the image capture device,
   but cannot be classified by the image capture device, or
   the KO which is determined by the image capture device (2) during classification falls below a defined threshold value,
to actuate the illuminating device such that the illumination intensity is increased or decreased in the region of the object.

Preferably, it is provided for the environment sensing device and the image capture device to be of different types. If, for example, the image capture device is a camera (optionally with downstream evaluation electronics), i.e., is of the camera type, the environment sensing device is another type, that is, not the camera type.

For example, it can be provided according to the invention that, when an object is detected or can even be classified by the environment sensing device, and this object is not detected, or is detected but cannot be classified, by the image capture device, the brightness in the region of the object is adjusted such that the image capture device can also detect and preferably also classify the object, in particular classify it correctly with a high degree of probability.

For example, the optical image capture device (optical sensor) itself or a further sensor system (environment sensing device) can thus request more (or less) light from the light source, for example high-resolution light source, in order to obtain the necessary support to classify the object.

With the invention, reliable object recognition and classification can be achieved, e.g. even at night, in poor weather or glare scenarios, and as a result better usability of the system can be achieved.

It can be provided for the illumination intensity to be increased or decreased in the region of the object when the KO falls below a defined threshold value KOₘᵢₙ for the KO confidence value. For example, the corresponding brightness information is obtained from the image information of the optical image capture device.

It can be provided for the environment sensing device to be designed to classify, in terms of type, an object sensed by the environment sensing device and situated and detected in the sensing region of the illuminating device and to determine a further confidence value, the so-called NKO confidence value, “NKO”, said NKO indicating the probability that the object type of the detected object has been established, in particular correctly,
depending on the NKO for the object, or
depending on the KO and the NKO for the object, or
   when KO<NKO.

It can be provided for the illumination intensity to be increased or decreased in the region of the object when the KO is less than the NKO. To increase the reliability of the object recognition considerably, in the case where the at least one environment sensing device can classify the object more reliably than the image capture device, the brightness is adjusted such that also the image capture device can classify the object more reliably or reliably. The object recognition reliability of the whole system is thus considerably improved.

Preferably, the system comprises confidence value determining means for determining the KO and/or the NKO. Typically, the confidence value determining means is an algorithm or algorithms which is/are executed in the form of one or more executable programs on a piece of hardware. An algorithm can be provided which determines KO and NKO, but it is also possible to provide a dedicated or at least one dedicated algorithm in each case for KO and NKO.

It can be provided for the system to comprise at least one controller for actuating the at least one illuminating device depending on KO, or on NKO, or on KO and NKO.

Confidence value determining means can be implemented for example by the controller or in the controller, for example as one or more algorithms, which are executed e.g. on the controller in order to calculate KO and/or NKO. The algorithm(s) can also be executed on a separate calculating device. The confidence value determining means are supplied with corresponding input data from the at least one image capture device, in particular optical image capture device, and/or the at least one environment sensing device, preferably non-optical environment sensing device. Measurement data of these devices form the input data, and the confidence value determining means deliver corresponding output data (KO and/or NKO) with which the controller is supplied.

It can be provided for the illuminating device to be designed to generate a motor vehicle beam pattern or a part of a motor vehicle beam pattern, the illuminating device comprising for example a dimmed beam module for generating a dimmed beam pattern and/or a full beam module for generating a full beam pattern or a combined module for generating a dimmed beam pattern and a full beam pattern.

For example, the illuminating device can use individually actuated light sources (e.g. devices which, by means of multiple light sources such as LEDs, can generate a beam pattern composed of multiple segments or of a plurality of pixels, the light sources generally being actuated independently of one another) or high-resolution systems (e.g. DLP, laser scanner systems, mini-LED systems, micro-LED systems, LCD systems, LCoS systems). With these, the brightness or illumination intensity can be adjusted in a targeted manner in the region of the object without affecting or excessively affecting the brightness or illumination intensity in other regions.

For the illuminating device, light sources which are not visible to humans (for example infra-red light sources) can also be used or can be used in combination with visible light sources.

For example, it is provided for the environment sensing device to comprise RADAR and/or LIDAR and/or an ultrasound-based sensor and/or an IR camera and/or a TOF (“time of flight”) camera and/or an MS (“multispectral”) camera.

Preferably, it is provided for the image capture device to comprise one or more cameras or one or more camera systems, in particular optical cameras/camera systems or an optical camera or an optical camera system. “Optical” means that said camera or said system or said device operates in the visible wavelength range.

It can be provided for the image capture device to operate in the visible wavelength range and/or in the non-visible wavelength range, for example in the IR range.

It can be provided for the illuminating device to be designed to illuminate the object continuously or for the illuminating device to be operated e.g. cyclically and preferably synchronised with the image capture device such that the object is illuminated only when the image capture device is active, or for the illuminating device to be designed to emit light flashes, in particular light flashes of short duration, at the object.

The duration of the light flashes is typically in the millisecond or microsecond range.

Preferably, it is provided for the illuminating device to be part of a motor vehicle headlight, in particular of the motor vehicle.

The aforementioned object is also achieved with a motor vehicle headlight for a motor vehicle, in particular for an autonomous or semi-autonomous motor vehicle, the motor vehicle headlight comprising an above-described system, the optical image capture device preferably being arranged in a lateral edge region of the headlight.

The invention is also achieved with a motor vehicle having a motor vehicle headlight, preferably two motor vehicle headlights, a left one and a right one, as described above, at least the illuminating device preferably being part of a motor vehicle headlight of the motor vehicle.

Finally, the invention is also achieved with a method for monitoring the environment of a motor vehicle, in particular an autonomous or semi-autonomous motor vehicle, wherein a system according to any one of claims 1 to 11 or at least one, or two, in particular a left and a right headlight of a motor vehicle according to claim 13 are used to carry out the method.

The invention is explained in more detail below with reference to the drawing. In the drawing,

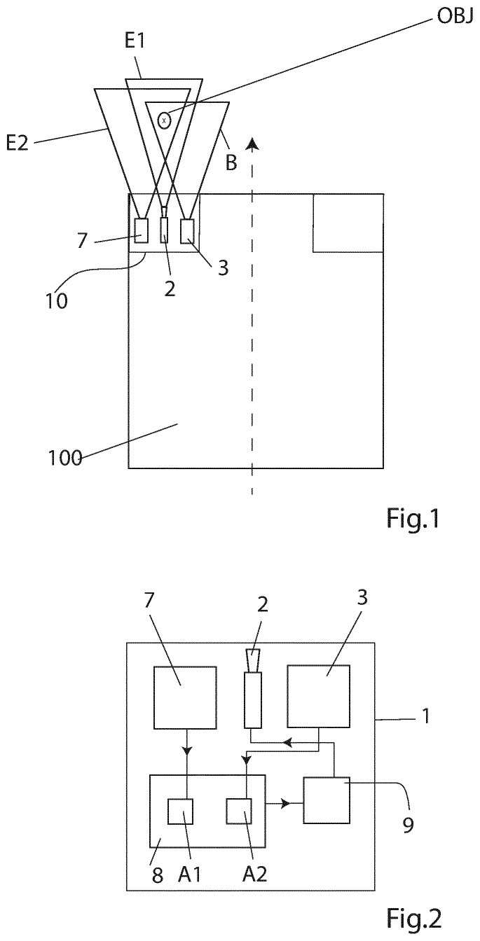

FIG. 1 shows a motor vehicle having a system according to the invention, and

FIG. 2 shows a system according to the invention in a schematic functional diagram.

FIG. 1 shows a motor vehicle 100, e.g. an autonomous or semi-autonomous motor vehicle, which has two motor vehicle headlights on the front; in the non-limiting example shown in FIG. 1, the left headlight 10 comprises a system 1 according to the invention, or such a system 1 is at least partially integrated in the headlight 10.

The system 1 according to the invention is used to monitor the environment of the motor vehicle 100, in particular the environment in front of the motor vehicle and/or to the side (left and/or right) in front of the motor vehicle. In the example shown, the system 1 comprises an image capture device 2, in particular an optical image capture device 2, wherein the image capture device 2 is designed to sense a sensing region E1 of the environment, and in particular to sense objects within the sensing region E1.

The image capture device 2 is preferably one or more cameras or one or more camera systems, preferably optical cameras/camera systems or an optical camera or an optical camera system. “Optical” means that said camera or said system or said device operates in the visible wavelength range.

The system further comprises an illuminating device 3, wherein the sensing region E1 of the at least one image capture device 2 can be illuminated partially, preferably fully, by the illuminating device 3, as shown schematically in FIG. 1 by the illumination region B. The wording “can illuminate” within the general context of the present invention means that either the illumination region B at least partially illuminates the sensing region E1 as soon as the illuminating device 3 is switched on, as shown in FIG. 1, or that the illuminating device 3 can deflect light into the sensing region E1.

The illuminating device 3 is preferably an illuminating device for generating a motor vehicle beam pattern or a part of a motor vehicle beam pattern, the illuminating device 3 being or comprising for example a dimmed beam module for generating a dimmed beam pattern and/or a full beam module for generating a full beam pattern or a combined module for generating a dimmed beam pattern and a full beam pattern. Preferably, the illuminating device 3 is installed correspondingly in the headlight 10.

For example, the illuminating device 3 can use individually actuated light sources (e.g. devices which, by means of multiple light sources such as LEDs, can generate a beam pattern composed of multiple segments or of a plurality of pixels, the light sources generally being actuated independently of one another) or high-resolution systems (e.g. DLP, laser scanner systems, mini-LED systems, micro-LED systems, LCD systems, LCoS systems). With these, the brightness or illumination intensity can be adjusted in a targeted manner in the region of the object without affecting or excessively affecting the brightness or illumination intensity in other regions.

For the illuminating device 3, light sources which are not visible to humans (for example infrared light sources) can also be used or can be used in combination with visible light sources.

It can be provided for the illuminating device 3 to be designed to illuminate the object OBJ continuously or for the illuminating device 3 to be operated e.g. cyclically and preferably synchronised with the image capture device 2 such that the object is illuminated only when the image capture device 2 is active, or for the illuminating device 3 to be designed to emit light flashes, in particular light flashes of short duration, at the object. The duration of the light flashes is typically in the millisecond or microsecond range.

The system 1 further comprises an environment sensing device 7, the environment sensing device 7 being designed to sense at least a part of the sensing region E1 of the image capture device 2, preferably the entire sensing region. The sensing region of the environment sensing device 7 is indicated in FIG. 1 with the reference sign E2. For example, it can be provided for the environment sensing device 7 to be designed as or comprise RADAR and/or LIDAR and/or to comprise an ultrasound-based sensor and/or an IR camera and/or a TOF (“time of flight”) camera and/or an MS (“multispectral”) camera and/or a thermal imaging camera. It can be provided for the image capture device 2 to operate in the visible wavelength range and/or in the non-visible wavelength range, for example in the IR range.

The system 1 or the image capture device 2 is designed to classify, in terms of object type, an object OBJ in the sensing region E1 of the image capture device 2, when said object has been detected, and to determine a confidence value, the so-called KO confidence value, “KO”, said KO indicating the probability that the object type of the detected object has been established, in particular correctly, by the image capture device 2.

Different object types are for example cars, trucks, single- or multi-tracked motorcycles, bicycles, pedestrians etc.

The KO thus indicates how confident the system is that a detected object has a certain object type.

The system 1 is further designed, when there is an object OBJ in the sensing region E1, as shown in FIG. 1,
depending on the KO for the detected object OBJ, or
when the environment sensing device 7 detects the object OBJ, and this object OBJ is not detected by the image capture device 2 despite being situated in the sensing region E1 of the image capture device 2, or
when the environment sensing device 7 detects the object, and this object is detected by the image capture device 2,
   but cannot be classified by the image capture device 2, or
   the KO falls below a defined threshold value,
or when the system 1 or the environment sensing device 7 is designed to classify, in terms of type, an object sensed by the environment sensing device 7 and situated and detected in the sensing region E1 of the image capture device 2 and to determine a further confidence value, the so-called NKO confidence value, “NKO”, said NKO indicating the probability that the object type of the detected object can be established, in particular correctly, by the environment sensing device 7,
   depending on the NKO for the object OBJ, or
   depending on the KO and the NKO for the object OBJ, or
   when KO<NKO, or
      to actuate the illuminating device 3 such that the illumination intensity is increased or decreased or is not changed in the region of the object OBJ.

For example, it can be provided according to the invention that, when an object is detected or can even be classified by the environment sensing device 7, and this object is not detected, or is detected but cannot be classified, by the image capture device 2, the brightness in the region of the object is adjusted, generally increased but also decreased, e.g. in the case of glare, such that the image capture device 2 can also detect and preferably also classify the object OBJ, in particular classify it correctly with a high degree of probability.

The KO of the image capture device 2 is thus increased, in particular increased so much that the detection and in particular classification of an object can be carried out by the image capture device 2 with a sufficiently high probability for the respective application and degree of confidence needed by said application.

For example, it can be provided for the illumination intensity to be increased or decreased in the region of the object OBJ when the KO falls below a defined threshold value KOₘᵢₙ for the KO confidence value.

The value for this defined threshold value KOₘᵢₙ in turn depends on the respective application.

It can also be provided for the illumination intensity to be increased or decreased in the region of the object OBJ when the KO is less than the NKO. To increase the reliability of the object recognition considerably, in the case where the one environment sensing device 7 can classify the object 2 more reliably than the image capture device 2, the brightness is adjusted such that also the image capture device 2 can classify the object 3 more reliably or reliably. The object recognition reliability of the whole system 1 is thus considerably improved.

FIG. 2 again shows a roughly schematic overview of components of the system 1 according to the invention, specifically the image capture device 2, the environment sensing device 7 and the illuminating device 3.

Preferably, the system comprises confidence value determining means A1, A2 for determining the KO and/or the NKO. Typically, the confidence value determining means is an algorithm or algorithms A1, A2 which is/are executed in the form of one or more executable programs on a piece of hardware 8. An algorithm can be provided which determines KO and NKO, but it is also possible to provide a dedicated or at least one dedicated algorithm A1, A2 in each case for KO and NKO.

Moreover, it can be provided for the system to comprise a controller 9 for actuating the illuminating device 3 depending on KO, or on NKO, or on KO and NKO, wherein KO and/or NKO are transmitted from the confidence value determining means A1, A2 or the hardware 8 on which these are executed to the controller 9.

It can also be provided for the controller 9 to be integrated in and/or executed on the hardware 8.

The system 1 as shown schematically in FIG. 2 can, for example, be integrated fully into a motor vehicle headlight and, for example, access components which are present anyway in the headlight, i.e., for example, the illuminating device. However, it can also be provided, for example, for the hardware 8 and/or the controller 9 to be part of the motor vehicle rather than part of the motor vehicle headlight. Alternatively or additionally, the image capture device 2 and/or the environment sensing device 7 can also be arranged outside the motor vehicle headlight in the motor vehicle.

1. A system (1) for monitoring the environment of a motor vehicle (100), in particular of an autonomous or semi-autonomous motor vehicle, the system (1) comprising:
at least one image capture device (2), in particular an optical image capture device (2), wherein the image capture device (2) is designed to sense a sensing region (E1) of the environment, in particular to sense objects within the sensing region (E1);
at least one illuminating device (3), wherein the sensing region (E1) of the at least one image capture device (2) can be illuminated partially, preferably fully, by the illuminating device (3); and
at least one environment sensing device (7), wherein the environment sensing device (7) is designed to sense at least a part of the sensing region (E1) of the image capture device (2), preferably the entire sensing region (E1), wherein the at least one environment sensing device (7) is designed in particular to detect objects,
wherein the image capture device (2) is designed
to classify, in terms of object type, an object situated in a sensing region of the at least one image capture device (2), when said object has been detected, and
in each case to determine a confidence value, the so-called KO confidence value, “KO”, said KO indicating the probability that the object type of a detected object can be established, in particular correctly, by the image capture device (2), and
wherein the system (1) is designed, when there is an object (OBJ) in the sensing region (E1),
when the environment sensing device (7) detects the object, and this object is not detected by the image capture device (2), or
when the environment sensing device (7) detects the object, and this object is detected by the image capture device (2)
but cannot be classified by the image capture device (2), or
the KO which is determined by the image capture device (2)
during classification falls below a defined threshold value,
to actuate the illuminating device (3) such that the illumination intensity is increased or decreased in the region of the object (OBJ).

2. The system according to claim 1, which is configured to increase or decrease the illumination intensity in the region of the object (OBJ) when the KO falls below a defined threshold value KOₘᵢₙ for the KO confidence value.

3. The system according to claim 1, wherein the environment sensing device (7) is designed to classify, in terms of type, an object sensed by the environment sensing device (7) and situated and detected in the sensing region (E1) of the illuminating device (2) and to determine a further confidence value, the so-called NKO confidence value, “NKO”, said NKO indicating the probability that the object type of the detected object has been established, in particular correctly,
depending on the NKO for the object (OBJ), or
depending on the KO and the NKO for the object (OBJ), or when KO<NKO.

4. The system according to claim 3, which is configured to increase or decrease the illumination intensity in the region of the object (OBJ) when the KO is less than the NKO.

5. The system according to claim 1, comprising confidence value determining means (A1, A2) for determining the KO and/or the NKO.

6. The system according to claim 1, comprising at least one controller (9) for actuating the at least one illuminating device (3) depending on KO, or on NKO, or on KO and NKO.

7. The system according to claim 1, wherein the illuminating device (3) is designed to generate a motor vehicle beam pattern or a part of a motor vehicle beam pattern, wherein the illuminating device (3) comprises a dimmed beam module (3) for generating a dimmed beam pattern and/or a full beam module (4) for generating a full beam pattern or a combined module for generating a dimmed beam pattern and a full beam pattern.

8. The system according to claim 1, wherein the environment sensing device (7) comprises RADAR and/or LIDAR and/or an ultrasound-based sensor and/or an IR camera and/or a TOF (“time of flight”) camera and/or an MS (“multispectral”) camera and/or a thermal imaging camera.

9. The system according to claim 1, wherein the image capture device (2) comprises one or more cameras or one or more camera systems.

10. The system according to claim 1, wherein the image capture device (2) operates in the visible wavelength range and/or in the non-visible wavelength range.

11. The system according to claim 1, wherein illuminating device (3) is designed to illuminate the object (OBJ) continuously, or wherein the illuminating device (3) can be operated cyclically and synchronised with the image capture device (2) such that the object is illuminated only when the image capture device (2) is active, or wherein the illuminating device (3) is designed to emit light flashes at the object.

12. The system according to claim 1, wherein the illuminating device (3) is part of a motor vehicle headlight (10), in particular of the motor vehicle (100).

13. A motor vehicle headlight for a motor vehicle (100), in particular an autonomous or semi-autonomous motor vehicle, wherein the motor vehicle headlight (10) comprises a system (1) according to claim 1.

14. A motor vehicle having a motor vehicle headlight (10), preferably two motor vehicle headlights, a left one and a right one, according to claim 13, wherein at least the illuminating device (3) is part of a motor vehicle headlight (10) of the motor vehicle (100).

15. A method for monitoring the environment of a motor vehicle (100), in particular an autonomous or semi-autonomous motor vehicle, wherein a system (1) according to claim 1 is used to carry out the method.

16. The system according to claim 10, wherein the non-visible wavelength range is the infrared (IR) range.

17. The motor vehicle headlight according to claim 13, wherein the optical image capture device (2) is arranged in a lateral edge region of the headlight (10).
